(19) United States
(12) Patent Application Publication
(10) Pub. No.: US 2005/0066311 A1
(43) Pub. Date: Mar. 24, 2005

(54) Autonomic execution tracking and correction of functions

(75) Inventors: Joachim Hagmeier, Stuttgart (DE); Albert Schaal, Tuebingen (DE); Torsten Teich, Stuttgart (DE)

Correspondence Address: Mark S. Walker;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/876,024

(22) Filed: Jun. 24, 2004

(30) Foreign Application Priority Data
Sep. 22, 2003 (DE) 03103503.3

(51) Int. Cl. G06F 9/44

(52) U.S. Cl. 717/128

(57) ABSTRACT

The present invention relates to computing systems, and in particular to a method for tracking the execution of a computer program during execution thereof. In order to reduce errors or fraud in the execution flow of the program it is proposed to insert so-called trace code instructions (TCI) (220, 222, 224, 226, 228, 230) multiply into the program's source code (20) in particular at crucial locations thereof. Said trace code when executed or interpreted in Interpreter-based programming languages—calculates some verification information, which can be used by checking its calculation results for determining if or if not the program execution path was the expected one. If an unexpected result occurs, predetermined, programmed measures can be undertaken according to the respective environment, application or security policy.

### 1. BACKGROUND OF THE INVENTION

1.1. Field of the Invention

The present invention relates to computing systems, and in particular to a method for tracking the execution of a computer program during execution thereof.

1.2. Description and Disadvantages of Prior Art

Prior art computing systems 8 mainly consist of an execution engine 10, program or code memory 12, data memory 14, and other functional parts, see FIG. 1 for reference. The execution engine 10 sequentially reads instruction codes (and instruction code arguments) from the code memory 12, and executes every single instruction according to the rules, which are stored in the execution engine itself. The data memory 14 is used to hold variable and constant data. It is accessed (ie, read from and written to) by special instruction codes. In conventional computing systems, the content of code memory 12 and data memory 14 form the actual computer program.

Additionally, there exist today interpreter based computing systems. In this case the data memory contains virtual instruction codes, and data of the program. The virtual instruction codes cannot be executed by the execution engine. A special program, so called interpreter, is used instead, which is stored in the program memory. The interpreter reads virtual instructions and their arguments from said data memory, and executes them according the rules, which are stored in the interpreter itself. One example of such a computing system is the Java Virtual Machine.

In conventional or interpreter bases computing systems, computer programs consist of instructions that are executed in sequence. It is expected that this sequence follows the programmed path; branching is expected to happen only as programmed in dependency of known events.

Unfortunately, the microprocessor that executes the instructions can be disturbed by electromagnetic fields, e.g., X-ray, or by fast changes in the electrical system powering the device in a way that can lead to execution of code not within the flow of the current execution path. This gives attackers the possibility to manipulate programs in a way that a program path is followed that was not intended by the programmer, or that the program operates with wrong data. Especially in sensitive computing areas where security is of high importance such disturbances and manipulations can cause great damage.

Today several prior art techniques exist to detect and react to errors in program execution:

First, sensitive areas like financial systems, aviation, or power plant controlling—to mention only a few—often work with redundancy where execution of the program takes place on more than one computer, and the results are periodically compared to detect malfunctions.

A disadvantage thereof is that multiple execution engines (processors) must be built into one single computer system. This increases costs of such a system in every aspect. For smaller devices, where space is an issue, this technique is often not applicable.

Second, since every instruction is divided into multiple execution stages (a.k.a. pico-instructions) by a processor, techniques have been developed in prior art to ensure correct and complete execution of the pico-instructions, as for example disclosed in U.S. Pat. No. 5,388,253. Here, hardware means are used to generate a signature corresponding to a macrocommand portion of a given instruction. Particular registers are necessary to store the “expected” signature. During runtime the signature is calculated and compared to the stored one.

This method is disadvantageously limited to errors, which occur while one instruction is executed by the processor. Manipulations to the program flow are not recognized as long every instruction is completely executed. Another disadvantage is, that the method is not applicable on most of today's processors, since special hardware elements must have been built into the processor.

Third, another method is known from U.S. Pat. No. 4,920,538, which uses a path information to check the correct execution of branches. The disadvantage is that this method detects errors in execution only at branch positions in the code flow. Another disadvantage is, that also here, special hardware elements are involved which hold and check the path information. A significant effort is needed to compute trees of execution paths beside/during the program development.

Further, several methods are known, which target the consequences of erroneous program execution, rather than reacting on the event that caused the error. E.g. storing data operations on a backup system and restoring data after loss or malfunction, e.g., as disclosed in U.S. Pat. No. 5,682,513) is the main purpose.

The disadvantage is that these methods need multiple computing systems as backup, they are not applicable on a single machine.

SmartCards for financial systems are one example for computer systems where errors in the execution flow can be of great harm. Redundant computing is not a solution in this area because of the limited size of the SmartCard and the limited available resources.

1.3. Objectives of the Invention

It is thus an objective of the present invention to provide a method and system with improved automatisms to track program code during its execution, especially for detecting errors or fraud during execution caused by manipulations or disturbances of the processor.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to its basic aspect a method for tracking the intended regular execution of a computer program during execution thereof, is disclosed, which is characterized by the features as follows:

a) executing additional program trace code instructions inserted in the source code of the program to be tracked in-between the regular instruction sequence given by the business target of the program,

b) said trace code instructions calculating verification information when executed,

c) checking at least once during program execution if said verification information is expected for regular execution of the program.

“Additional” instructions are meant to be instructions, which are not necessary to achieve the pure business goal of the program or subprogram, function, etc. Thus, their only purpose is to check the correct program execution as defined by the “regular” instructions and intended by the programmer when developing the source code.

“In-between” means that the sequence of regular instructions is interrupted by one or more inserted trace code instructions, further referred in here as TCI. After one or two or more TCIs the next regular instruction follows.

Said TCIs generate some verification information. This may be any calculation from which the desired/originally intended regular execution flow, i.e. program flow can be uniquely derived. Examples are given further below.

Thus, the advantage is achieved that the path, in which a program is executed, and which is defined by the sequence of instructions and the parameters with which certain instructions are executed, can be tracked. The calculated verification information is used to decide, if or if not the actual path or only a section thereof was the correct path to be followed and intended by the programmer.

When said trace code instructions are provided at “crucial” code locations selected from the group:

a) before and/or after crucial regular instructions,

b) before and/o after branch instructions,

c) before and/or after execution of a subroutine, function, and the like, then useful locations are defined to place the trace code. The meaning of crucial” is of course dependent from the actual environment the program runs in. It may be in a banker application, entering of a password, for example, or the output of money, or the like.

When said trace code instruction calculations are immediately followed by checking the verification information they calculated immediately before, or when first a previous trace code is checked followed by the generation of the current verification information, ie the inversed case, the method is further improved against fraud and physically impacting disturbances, as e.g. X-ray radiation producing some faulty instruction results or the like. This is useful in particular for software running in satellites or in rockets, space vehicles, etc.

When further, said trace code instructions include a calculation of current values of program variables, this may be a direct way to track the actual parameters with which the tracked program is actually run.

When further the program execution is repeated automatically after the verification step yielded unexpected verification information, the above-mentioned X-ray forced errors may be cured.

When, after the verification step yielded unexpected verification information, predetermined measures are undertaken dependent of the actual security policy present in the respective application, then the consequences may be freely defined by a programmer in case of errors. Thus, sometimes a program abort will be useful; sometimes a repetition of program sections may be helpful, or fully different things as e.g., issuing an alarm (possibly silent) to a surveillance instance, etc., may be performed.

When during runtime of said program a dynamically selectable trace code generation routine (function, etc.) is executed, a strong measure is found against fraud, as the defrauding person cannot foresee, which trace code will be used next. Such runtime-dynamical trace code generation may include for example the selection of any meta-information available, e.g., time-of-day, random numbers, user-related information, etc, which may be used via a secret hash-function stored on the computing system maybe in an encoded form if necessary, to select a particular trace code generation code from a larger number of such codes. Thus, a hacker cannot predict the trace code and thus cannot know the correct verification information.

Thus, such trace code generation routine is organized self-modifying dependent of predetermined runtime parameters, such as values of variables, storage addresses, time date data, personal IDs, etc. That further improves the inventive method improved against fraud.

A further preferred feature of the present invention comprises to include some hooks, i.e. some default security code at basically similar or identical code positions as mentioned before, which may be added to already present trace code or may replace it. Such hooks can advantageously overloaded, i.e. “filled” just before the actual runtime of the program with an executable trace code patch file, which may be provided very actually and in the strongest form possible, e.g. by downloading it from a respective update security server associated with the program vendor site, in order to be protected against the latest known fraud attacks to the program.

It should be added that information required for above check in step c) is either hard-coded in the source code as part of the trace code instruction and thus stored in main memory, or, which is more preferred, trace code fetches its required reference data from a separate memory section in main memory, wherein this section can be later overwritten with different data. In both alternatives, trace code reference data must be pre-calculated.

A further alternative is to calculate the reference data dynamically at some programmed time during runtime of the program, before the check is performed. This alternative is advantageous, as some dynamically calculated variable can be integrated into the check, for example a predetermined random number or a predetermined result of a preceding program instruction, program section or the like. Also in this alternative, the check data is stored in memory.

The inventive principle works on the functional level of computer programs. It is implemented preferably in software, neither additional, nor special hardware is needed therefore. It is applicable in conventional computing systems, and in interpreter based computing systems. Errors or malfunctions e.g. introduced by hacking the program are detected immediately after they occur, namely by the next trace code. Thus, the consequences of said errors or malfunctions can be limited to a minimum. The computer program detects that its execution flow did not follow the correct path. Therefore it can react before security relevant operations are disturbed or secret information is revealed. The inventively protected program can restore corrupted data or can correct the execution flow by repeating or aborting the current operation.

### 3. BRIEF DESCRIPTION OF THE DRAWINGS

The present invention is illustrated by way of example and is not limited by the shape of the figures of the drawings in which:

FIG. 1 is a schematic block diagram representation of a prior art computing system illustrating the relevant functional parts, in which the inventional parts may be performed;

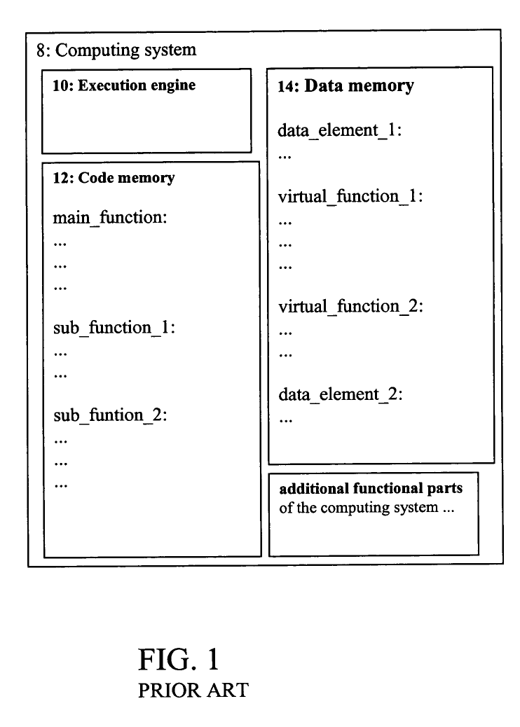

FIG. 2 is a schematic block diagram representation of a source code portion illustrating the insertion of trace code into classic program code according to the invention;

FIG. 3 is a schematic block diagram representation of a source code portion illustrating the insertion of trace code into a virtual function in Interpreter-based program code according to the invention;

FIG. 4 is a schematic block diagram representation illustrating the essential steps of the control flow performed during the inventional method according to a preferred embodiment;

### 4. DETAILED DESCRIPTION OF THE PREFERRED EMBODIMENT

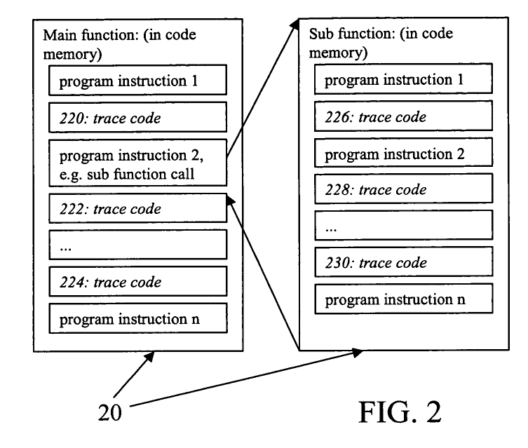

With general reference to the figures and with special reference now to FIG. 2, a source code fragment of a computer program is shown, during the development of which additional program instructions (“trace code”) are inserted according to this inventive embodiment in-between the regular instructions, which build the functional body of the program (“program code”, “program instructions”). Thus a trace code 220 is inserted between program instruction 1 and program instruction 2, where the latter one may for example be a call instruction to a subfunction.

Also within the subfunction, which is depicted in the right hand portion of the figure trace code instructions 226, 228 and 230 are interposed between respective regular program instructions enumerated 1, 2, . . . n.

After returning from the subfunction, a further trace code instruction 222 is inserted, and in the further program source code a further TCI 224 is placed. Of course in a real program, the number of TCIs can be fairly increased, dependent of the program itself and the doing thereof.

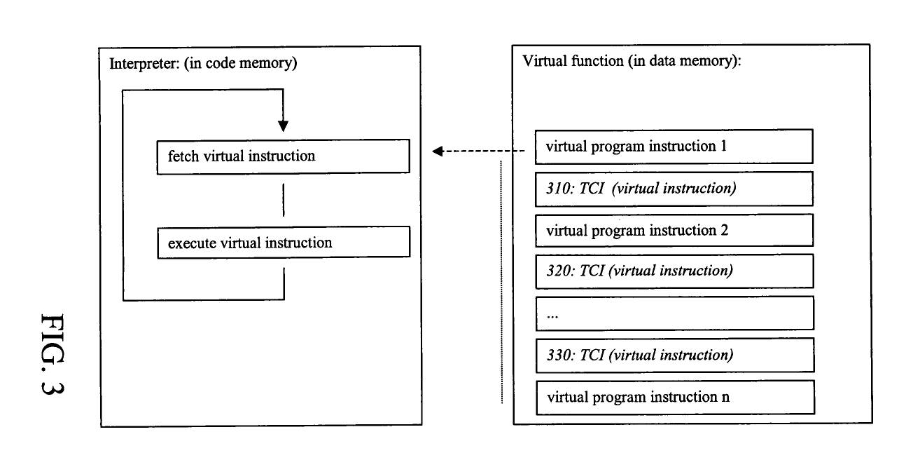

In an interpreter based computing system, the above mentioned additional instructions are virtual program instructions, ie “virtual trace code”, which are inserted in-between the regular virtual instructions stored in the data memory, as shown in FIG. 3 for trace code virtual instructions 310, 320, and 330 exemplarily.

The interpreter processes the trace code instruction basically in the same manner as regular instructions, see FIG. 3, left hand portion.

With reference to both, compiler-based programming languages (FIG. 2) and interpreter based languages (FIG. 3) the trace code inserted and used according to the invention dynamically calculates program position information while the program code is executed. Position information means any information, which may be evaluated by the programmer in order to derive there from the current “position” of execution, ie the instruction actually executed in the program flow during program execution, ie at runtime.

According to a preferred feature of the invention the program position information generated by a currently executed trace code instruction is systematically checked by the subsequent trace code instruction appearing next below in the source code. As a consequence, the trace code consists of a block of several instructions, which first check the program position information calculated before, and then recalculates the program position information for actualisation purposes.

According to the present invention the program position information can be selected from types of the following group:

1. a simple counter variable, ie either a regular variable or a trace code variable introduced separately;

2. an address information derived from the current position, i.e. the currently executed instruction;

3. a checksum or the like calculated over some or all previous program instructions;

4. a checksum or the like calculated over some selected or all previous program addresses;

5. other logical, arithmetical, procedural, statistical values;

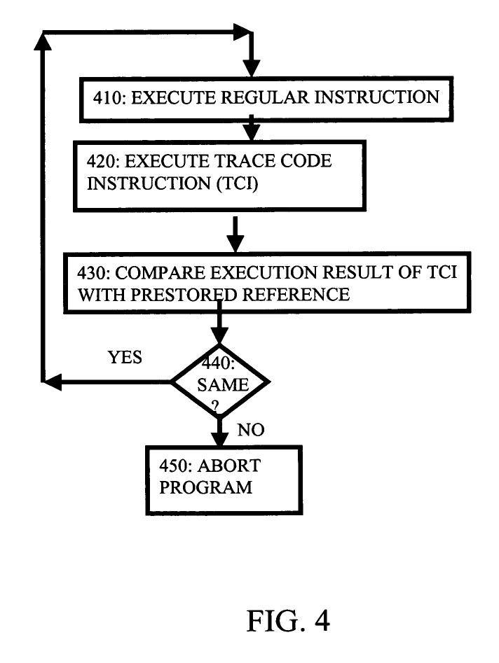

With reference to FIG. 4 the additional control flow introduced by the present invention is illustrated in a selected example as follows:

First, a regular instruction is executed in a step 410. Then a first trace code instruction is executed, step 420, which generates verification information from the above-mentioned parameters. Then a second trace code instruction is executed, step 430, which compares said run-time calculated verification information with a respective, pre-stored reference position information expected for regular run-time behavior.

Then a check 440 is performed, in which it is determined if the verification information is identical to that one, which was expected for the correct—desired—program path. In case, it is correct—see the YES branch of decision 440—it is branched back to step 410 in order to continue the program. Otherwise—see the NO- branch of decision 440—the program is aborted in this special example.

According to the present invention the current value of the program position information, which is used as verification information, is stored in one or more “program state variable(s)”. The program state variable can be a global value, shared by all the trace codes of a computer program, or a local value, which is valid only in the scope of a specific function or module of the computer program. If the trace code detects errors by comparing the program state variable with an expected value, or by checking the plausibility of the value in the current program state variable, see step 440 above, it may react according the actually prevailing security policy of the computer program. One effect of this technique is that due to the trace code the absolute code size of the program is increased, and the over-all execution performance of the program may be worse than without trace code. These effects can be reduced by limiting and carefully selecting the locations in the program code, where the trace code is inserted.

Next, two examples are given to increase clarity of the present disclosure.

### Example 1

Sub-functions write the program position information into a program state variable, which is owned by the calling function. The calling function verifies that the program state variable was written as expected, if not, it can react according to its security rules.

The calling function initializes the program state variable such that it references a list of addresses of each subfunction invoked. The subfunction compares the current address list entry referred to by the program state variable with its own address using a trace code. The trace code is designed such that it advances the program state variable to the next address list entry. The following code fragment serves for further illustration of the functional elements used hereby:

ThisFunction( )
{

; trace code:
; check, if pointer at current address list refers to this
; function
if ([PSV]!=&ThisFunction) then signalize error!
; save the PSV and set the PSV to the list of this function
save PSV
PSV = ThisFunction.list
; invoke a sub-function
Subfunction1( )
; invoke another sub-function
Subfunction2( )
; restore the PSV of the calling function
restore PSV
; advance the PSV, signalizing to the calling
; function that this function was completely
; executed
PSV++

}
Subfunction1( )
{

; trace code:
; (same code as in ThisFunction)
; ...

| | |
|---|---|
| } | |
| CallingFunction.list | = {..., &ThisFunction, ..., NULL} |
| ThisFunction.list | = {&Subfunction1, &Subfunction2, NULL} |
| Subfunction.list | = {..., NULL} |

### Example 2

Very often, address based execution tracking (as shown in example 1) reduces execution performance significantly. In this case, a simple but effective implementation can be to define the program state variable as a simple counter, and to implement the operation on the program position information as a numerical increment operation. At well-defined points the calling function can simply check the current value of the program state variable if it contains the number of subfunctions invoked as expected.

The following code fragment serves for further illustration of the functional elements used hereby:

ThisFunction( )
{

; save the PSV of the calling function and set the PSV for
this
; function
save PSV
PSV = 0
; invoke a subfunction
Subfunction1( )
; execute the trace code here
; if Subfunction1 was not executed, then we will recognize

it here

PSV == 1?
; ...
; loop in program flow:
for (...) {

Subfunction2( )
; execute the trace code here
PSV == 2?
; adjust the PSV for next pass of the loop
PSV −−

}
; end of loop
; ...
; restore the PSV of the calling function
restore PSV
; advance the PSV, signalizing to the calling
; function function that this function was completely
; executed
PSV ++

}
Subfunction1( )
{

...
PSV ++

}

Although the present invention is basically preferred to be implemented as a pure software implementation, it can be realized in hardware, software, or a combination of hardware and software. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein. A typical application are also chip card applications, in which the tracked program is stored on the chip card and the processor for the program is also implemented thereon.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A method for tracking the execution of a computer program during execution thereof, characterized by the steps of:
a) executing additional program trace code instructions inserted in the source code of the program to be tracked in-between the regular instruction sequence given by the business target of the program;
b) said trace code instructions calculating verification information from program position information when executed;
c) comparing at least once during program execution; and
a run-time calculated verification information with a respective, pre-stored reference position information expected for regular execution of the program.

2. The method according to claim 1, in which the program position information can be selected from the following group of different types:
a) a counter variable;
b) an address information derived from the current execution position;
c) a checksum calculated over some predetermined or all previous program instructions;
d) a checksum calculated over some selected or all previous program addresses; and
e) other logical, arithmetical, procedural, statistical values.

3. The method according to claim 1, in which said trace code instructions are provided at code locations selected from the group:
a) before and/or after crucial regular instructions;
b) before and/or after branch instructions; and
c) before and/or after execution of a subroutine, function, and the like.

4. The method according to claim 1, in which said trace code instruction calculations are immediately followed by checking the verification information they calculated immediately before.

5. The method according to claim 1, in which the step of checking the verification information of a preceding trace code instructions is followed by the step of generating the current verification information.

6. The method according to claim 1, in which said trace code instructions include a calculation of current values of program variables.

7. The method according to claim 1, in which the program execution is repeated automatically after the verification step yielded unexpected verification information.

8. The method according to claim 1, in which after the verification step yielded unexpected verification information, predetermined measures are undertaken dependent of the actual security policy present in the respective application.

9. The method according to claim 1, in which during runtime of said program a dynamically selectable trace code generation routine is executed.

10. The method according to claim 1, in which said trace code generation routine is organized self-modifying dependent of predetermined runtime parameters.

11. The method according to claim 1, in which a default security code is included as trace code instruction, which can be overloaded by a respective updateable patch file.

12. A computer system having means for performing the steps of a method according to one of the preceding claims 1.

13. The computer system according to the preceding claim being a chip card.

14. A computer program implementing a security-relevant application for execution in a data processing system and characterized by computer program code portions for performing the steps of:
a) executing additional program trace code instructions inserted in the source code of the program to be tracked in-between the regular instruction sequence given by the business target of the program;
b) said trace code instructions calculating verification information from program position information when executed; and
c) comparing at least once during program execution a run-time calculated verification information with a respective, pre-stored reference position information expected for regular execution of the program, when said computer program code portions are executed on a computer.

15. The computer program according to the preceding claim, wherein the program position information can be selected from the following group of different types:
a) a counter variable;
b) an address information derived from the current execution positions
c) a checksum calculated over some predetermined or all previous program instructions;
d) a checksum calculated over some selected or all previous program addresses; and
e) other logical, arithmetical, procedural, statistical values.

16. A computer program product stored on a computer usable medium comprising computer readable program means for causing a computer to perform the method of anyone of the claims 1, when said computer program product is executed on a computer.
